(19) United States
(12) Patent Application Publication
(10) Pub. No.: US 2013/0331742 A1
(43) Pub. Date: Dec. 12, 2013

(54) DEVICE AND METHOD FOR ANKLE REHABILITATION

(71) Applicants: Steven David Aupperle, Morton, IL (US); Jacob Evan Aupperle, Morton, IL (US)

(72) Inventors: Steven David Aupperle, Morton, IL (US); Jacob Evan Aupperle, Morton, IL (US)

(21) Appl. No.: 13/491,268

(22) Filed: Jun. 7, 2012

(51) Int. Cl. A61H 1/02

(52) U.S. Cl. 601/27

(57) ABSTRACT

A device and method for facilitating both isolation and therapeutic exercises of a human appendage, specifically, an ankle and adjacent regions. The device includes a ball joint hinge, allowing a large range of motion, in combination with a locking mechanism that restricts all movement. The device can be utilized for methods to stretch and strengthen anatomical structures that have been damaged in a therapeutic manner.

### FIELD OF THE INVENTION

The present invention relates generally to a device and method for rehabilitation of human appendages and, more particularly, to a device which facilitates therapeutic exercises for a human ankle and adjacent regions. Ankle trauma can require both a brace for isolation from movement and rehabilitation exercises to regain strength and full range of motion. Failure to timely stretch and strengthen the injured area as it heals can result in loss of range and motion. The present invention both immobilizes the foot in a locked position and allows 360 degree rotation of the foot in an unlocked position.

### BACKGROUND

A properly functioning ankle joint, where the foot and leg segments meet, requires a wide range of motion. The ankle joint comprises three major articulations: the talocrural joint, the subtalar joint, and the distal tibiofibular syndesmosis. The talocrural joint behaves like a hinge joint by allowing plantar flexion, or moving the foot so that the toe goes down, and dorsiflexion, or moving the foot so that the toe reaches up towards the shin. The talocrural joint is mainly supported by several ligaments, namely the anterior talofibular ligament (ATFL), the calcaneofibular ligament, and the posterior talofibular ligament at the lateral aspect of the ankle as well as the deltoid ligament in the medial aspect of the ankle. The ATFL is the weakest among the lateral ligaments and is most commonly injured in a lateral ankle sprain.

The subtalar joint is formed by the articulation between the bottom of the talus and the calcaneus. It consists of the anterior subtalar joint and the posterior subtalar joint. The anterior subtalar joint is formed from the head of the talus, the anterior-superior facets, the sustentaculum tali of the calcaneus, and the concave proximal surface of the tarsal navicular. The posterior subtalar joint is formed between the inferior posterior facet of the talus and the superior posterior facet of the calcaneus. The anterior and posterior subtalar joints behave like a single ball-and-socket joint and share a common oblique axis of rotation, which averages a 42-degree upward tilt and a 23-degree medial angulation from the perpendicular axes of the foot. This articulation allows inversion and eversion, or supination and pronation as described as a triplanar motion. The subtalar joint is supported by three groups of ligaments, namely the deep ligaments, the peripheral ligaments, and the retinacula. Together these ligament groups stabilize the subtalar joint and form a barrier between the anterior and posterior joint capsules.

The distal tibiofibular syndesmosis is formed by the articulation between the distal tibia and fibula. The joint is mainly stabilized by a thick interosseous membrane, with the anterior and posterior inferior tibiofibular ligaments, to form the stable roof for the mortise of the talocurural joint. This joint allows limited translation and rotation during talocrural dorsiflexion and plantarfexion to accommodate the asymmetric talus while maintaining congruency. Injury to this ligament group is rare, and is often termed ankle syndesmosis injury, syndesmotic ankle sprain, or high ankle sprain. Syndesmosis ligamentous sprains are commonly treated by restricting movement to use of a walking boot for several weeks, thereby allowing the interosseous tibiafibular ligament to heal by providing resistance to avoid the distal tibia and fibula to separate apart. The length of time of immobilization will vary among patients and will depend on the severity of the sprain. Patients can work on controlled open-chain range of motion while keeping weight off the foot, focusing on dorsiflexion and plantar flexion.

Lateral ankle sprains are common acute injuries suffered by athletes. The most common mechanism for a lateral ankle sprain is excessive inversion and plantar flexion of the rearfoot on the tibia. The injured ligaments are located on the lateral aspect of the ankle and include the anterior talofibular, the posterior talofibular, and the calcaneofibular. With lateral ankle sprains, the severity of the ligament damage will determine the classification and course of treatment. In a grade 1 sprain, there is stretching of the ligaments with little or no joint instability. Rehabilitation can often start immediately after initial management for pain and swelling of the grade 1 sprain. Time loss from physical activity for a grade 1 sprain is typically less than one week. Grade 2 sprains occur with some tearing of ligamentous fibers, resulting in moderate instability of the joint. Pain and swelling are moderate to severe and often immobilization is required for several days. Rehabilitation often requires a longer period of time than a Grade 1 sprain. A grade 3 sprain is a total rupture of a ligament or tendon with gross instability of the joint, often requiring surgery to repair or replace the damaged part. Pain and swelling is so debilitating that weight bearing is impossible for a period of time, requiring a brace to prevent motion.

There is a general consensus to conservatively treat grade 1 and 2 ankle ligamentous injuries with functional exercises. Regaining full range of motion, strength, and neuromuscular coordination are paramount during rehabilitation. Functional treatment protocols to manage ankle ligament injuries include flexibility exercises, strength and balance training, ankle joint proprioception and muscular strength training, isometric and isotonic strength training, and even exercises in water. Isometrics and open-chain range of motion can be completed by those patients who are non-weight bearing. Researchers believe that functional exercises are more effective than immobilization in terms of return to sports, return to work, reduction in persistent swelling, patient satisfaction, as well as restoration of ankle stability and range of motion.

For example, preventing equines contracture is extremely important during the rehabilitation period following corrective surgery. A removable brace is required to immobilize the foot, and the patient tends to wear it for the majority of the day to prevent the shortening of the gastro-soleus complex. The brace is removed to perform hindfoot motion therapeutic exercises. The amount of time spent immobilized by the brace is vastly disproportional to the time spent performing necessary exercises. Motion is sacrificed in an effort to prevent muscle contractures that would later prevent the patient from walking without a limp.

Nearly all lower extremity injuries benefit from rehabilitation programs that include therapeutic exercise. Unlike the present invention, current devices only perform a single function. For example, a brace is used to restrict movement immediately following trauma to a lower extremity. Upon reaching a point where rehabilitation exercises become necessary, the brace must be removed. In addition, continuous passive motion machines can be incorporated into the rehabilitation exercises. This requires a second type of brace for the leg and foot, which is then attached to a machine to force the continuous motion exercises.

There is a need for a single device to restrict movement of the injured area during locomotion which does not require removal for rehabilitative exercises.

A general object of the invention is to provide a device which can be utilized throughout the post-trauma period for rehabilitation of lower extremity injuries.

Another general object of the invention is to provide a device that can be attached to a machine which provides continuous passive motion to an injured extremity.

Yet another general object of the invention is to utilize the device during rehabilitation exercises by attaching cords to the foot member, creating resistance and/or guidance as the wearer performs stretching and strengthening movements by pulling and/or guiding the cords.

A more specific object is to provide a method to improve tibiotalar, subtalar, and transtarsal motion during the rehabilitation period of a hindfoot injury.

The general object of the invention can be obtained by introducing a ball-and-socket joint near the area where the Achilles tendon attaches to the calcaneus, or roughly where the tibiotalar and subtalar joints are located, into a leg-and-foot brace that can be locked into an immobilized state or unlocked to allow movement of the foot member in 360 degrees.

Further objects and advantages will become apparent as the description proceeds and the features of novelty which characterize the present invention will be pointed out with particularity in the claims annexed to and forming a part of the specification.

### SUMMARY OF THE INVENTION

The present invention relates to a foot and leg brace that incorporates a ball-and-socket joint hinge in the heel. The foot member and the calf member of the brace can be removably affixed to each other, thereby immobilizing the foot in relation to the lower leg. When the attachment is removed from the foot member and the calf member, the ball-and-socket joint allows the wearer to move the foot member 360 degrees in relation to the calf member. Cords can be attached to the foot member and used by the wearer to perform resistance and guidance exercises to increase range of motion and strength. The device can also be attached to a motorized unit to mechanize a continuous passive motion of the foot member in relation to the calf member on behalf of the wearer and aid in the rehabilitation process.

### BRIEF DESCRIPTION OF THE DRAWINGS

The aforementioned and other features and objects of this invention, and the manner of attaining them, will become apparent and the invention itself will be better understood by reference to the following description of several embodiments of the invention taken in conjunction with the accompanying drawings, wherein:

FIG. 1 is an exploded side view showing the ball-and-socket joint of the present invention;

FIG. 2 is a side view of one embodiment of the present invention;

FIG. 3 is a front view of one embodiment of the present invention;

FIG. 4 is a rear view of one embodiment of the present invention;

FIG. 5 is a bottom view of one embodiment of the present invention; and

FIG. 6 is a top view of one embodiment of the present invention.

Corresponding reference characters indicate corresponding parts throughout the several views. Although the drawings represent several embodiments of the present invention, the drawings are not necessarily to scale and certain features may be exaggerated in order to better illustrate and explain the present invention. The exemplification set out herein illustrates embodiments of the invention, in one form or another, and such exemplifications are not to be construed as limiting the scope of the invention in any manner.

### DETAILED DESCRIPTION

The present invention relates specifically to a device for rehabilitating a human appendage. The device utilizes a ball-and-socket joint, comprising a spherical ball enclosed by a proximal socket hemisphere and a distal socket hemisphere. The ball-and-socket joint has a bisected hemisphere member radiating outward from the spherical ball, comprising a proximal socket quartersphere member and a distal socket quartersphere member. The proximal socket quartersphere is fixedly attached to the proximal socket hemisphere. Likewise, the distal socket quartersphere is fixedly attached to the distal socket hemisphere. A connective member fixedly attaches the proximal socket quartersphere to the distal socket quartersphere. The connective member allows the ball and joint socket to maintain full functionality. Either the proximal socket quartersphere, the proximate portion of the connective member, or both is/are fixedly attached to the device's calf member. Similarly, either the distal socket quartersphere, the distal portion of the connective member, or both is/are fixedly attached to the device's foot member.

The device may resemble a traditional leg-and-foot brace, wherein the calf member and the foot member are similar in shape and length to traditional structural supports. However, the heel of the traditional brace is replaced with a ball-and-socket joint, allowing the calf member and the foot member to move independently of each other. The connective member prevents the device from dissolving into separate pieces.

At least one calf accommodating strap can be fixedly connected to said calf member. Other means can be used to secure the wearer's calf to the device's calf member. Such means can include, but are not limited to, at least one strap, cord, belt, pressure band, rubber band, rope, twine, hook-and-loop fastener, gauze, cloth, wrapping means, or a combination thereof.

At least one foot accommodating strap can be fixedly connected to said foot member. Other means can be used to secure the wearer's foot to the device's foot member. Such means can include, but are not limited to, at least one strap, cord, belt, pressure band, rubber band, rope, twine, hook-and-loop fastener, gauze, cloth, wrapping means, or a combination thereof.

At least one cord can be fixedly attached to the foot member of the device. The cord should have a length long enough to be grasped by the wearer or a second party, such as a physical therapist. This cord can be used to increase the strength and/or flexibility of the wearer's muscles and connective tissues.

In another embodiment, the present invention includes a separate machine which can be removably attached to the boot-type device. In addition to recording the force and angular movement of the wearer, it can also provide continuous passive motion of the foot member in relation to the calf member. This forced continuous passive motion has been shown to improve cartilage healing as well as hindfoot flexibility.

The present invention can be constructed of rigid materials including, but not limited to, plastic, corrugated plastic, metal, corrugated metal, alloy, corrugated alloy, wood and wood products, cardboard, corrugated cardboard, rigid paper products, stiffened fabric, fiberglass, any suitable rigid material, or combinations thereof. The present invention can also be constructed of non-rigid materials including, but not limited to, rubber, vinyl, flexible fabric, screen mesh, or combinations thereof. Additional materials used to affix the various pieces together, include, but are not limited to, liquid adhesives, solid adhesives, tape, clipping means, clasping means, pressured bands, rubber bands, ropes, strings, twines, wires, tacks, nails, screws, hook and loop fasteners, or combinations thereof.

The present invention can be pre-formed, cast, or made using some other manufacturing or construction technique known to a person having ordinary skill in the art. Generally, the present invention will be available in variable sizing options to accommodate the large diversity of human appendage shapes and lengths.

In another embodiment of the present invention, a means for multiple weights can be added to the foot member. One embodiment includes at least one hole in the foot member, wherein a length of cord is fixedly attached through the hole. Various weights can then be hung or strung through the cord. Another embodiment includes at least one weight fixedly attached to a hook that can be hung to the foot member.

In yet another embodiment of the present invention, the device has at least one handle, handhold, and/or grip. The handle, handhold, and/or grip can be placed anywhere on the device.

As used herein the phrase “fixedly connected” generally refers to the physical attachment in any way of at least one separate piece to another separate piece according to a person having ordinary skill in the art, including, but not limited to, liquid adhesives, solid adhesives, clipping means, pressured bands, rubber bands, ropes, strings, twines, wires, tacks, nails, screws, hook and loop fasteners, or a combination thereof.

As used herein the term “quartersphere” refers to a hemisphere that is bisected to reveal two symmetrical halves.

The foregoing descriptions of illustrated embodiments of the present invention have been offered for purposes of description, and are not intended to be exhaustive or to limit the present invention to the precise forms disclosed. The descriptions were selected to best explain the principles of the present invention and practical application of these principals to enable others skilled in the art to best utilize the present invention in various embodiments and various modifications as are suited to the particular use contemplated. It is intended that the scope of the present invention not be limited by the specification, but be defined by the claims set forth below.

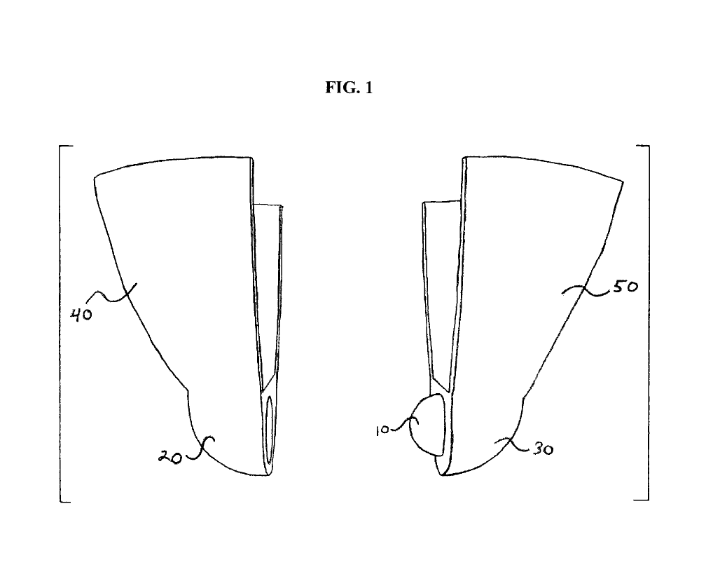

Referring to the illustrations, FIG. 1 is an exploded side view showing the ball-and-socket joint of the present invention. The spherical ball 10 is located within both the proximal socket hemisphere 20 and the distal socket hemisphere 30. The proximal socket hemisphere 20 is fixedly attached to the proximal socket quartersphere 40. Likewise, the distal socket hemisphere 30 is fixedly attached to the distal socket quartersphere 50. The person wearing this device inserts the heel of the ankle requiring rehab into the void of the quartersphere location.

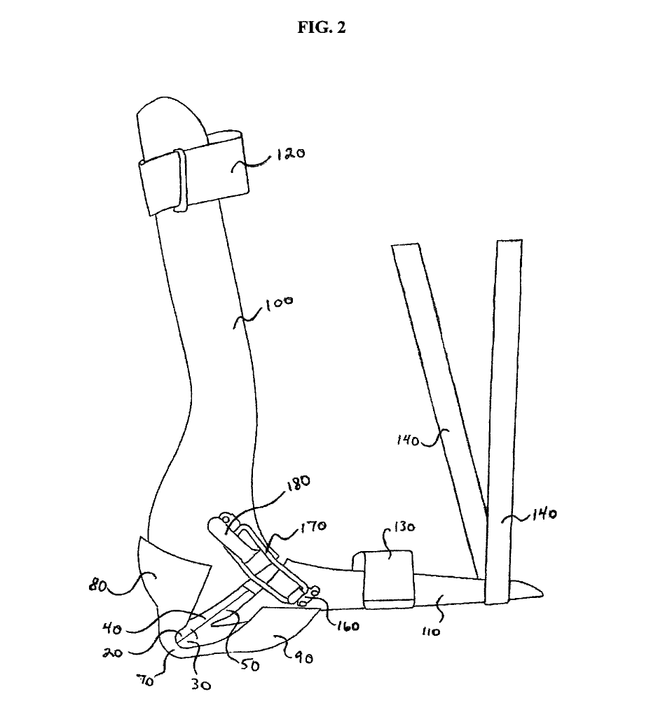

FIG. 2 shows a side view of one embodiment of the present invention. The opposite side of this embodiment is a mirror image. The proximal socket hemisphere 20 and the proximal socket quartersphere 40 are adjacent to the distal socket hemisphere 30 and the distal socket quartersphere 50. A connective member 70 having a proximate portion 80 and a distal portion 90. The proximate portion of the connective member 80 is fixedly attached to the proximal socket quartersphere 40. The proximate portion of the connective member 80, the proximal socket quartersphere 40, or both is/are fixedly connected to the calf member 100. Similarly, the distal portion of the connective member 90 is fixedly attached to the distal socket quartersphere 50. The distal portion of the connective member 90, the distal socket quartersphere 50, or both is/are fixedly connected to the foot member 110. A latch system 150 comprising a clasp 160, a release lever 180, and a loop 170 is used to secure the calf member 100 to the foot member 110. The release lever 180 is fixedly attached to the calf member 100. The clasp 160 is fixedly attached to the foot member 110. A calf accommodating strap 120 can be fixedly attached to the calf member 100 so that the wearer's calf is secured to the device. A foot accommodating strap 130 can be fixedly attached to the foot member 110 so that the wearer's foot is secured to the device. A cord 140 can be slipped around or fixedly attached to the foot member 110 to aid the user with rehabilitative exercises.

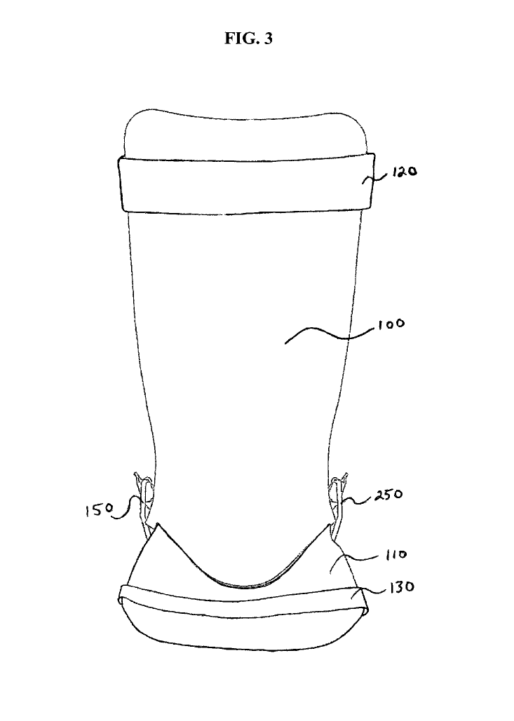

FIG. 3 is a front view of one embodiment of the present invention. The calf member 100 is secured to the foot member 110 by latch systems 150 and 250. The foot accommodating strap can be fixedly attached to the foot member 110. The calf accommodating strap 120 can be fixedly attached to the calf member 100.

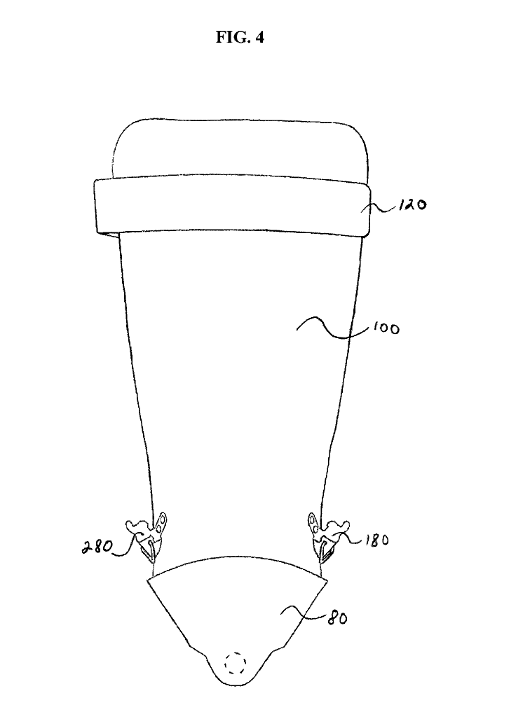

FIG. 4 is a rear view of one embodiment of the present invention. Release levers 180 and 280 are fixedly attached to the calf member 100. The proximate portion of the connective member 80 is fixedly attached to the calf member 100. The calf accommodating strap 120 can be fixedly attached to the calf member 100.

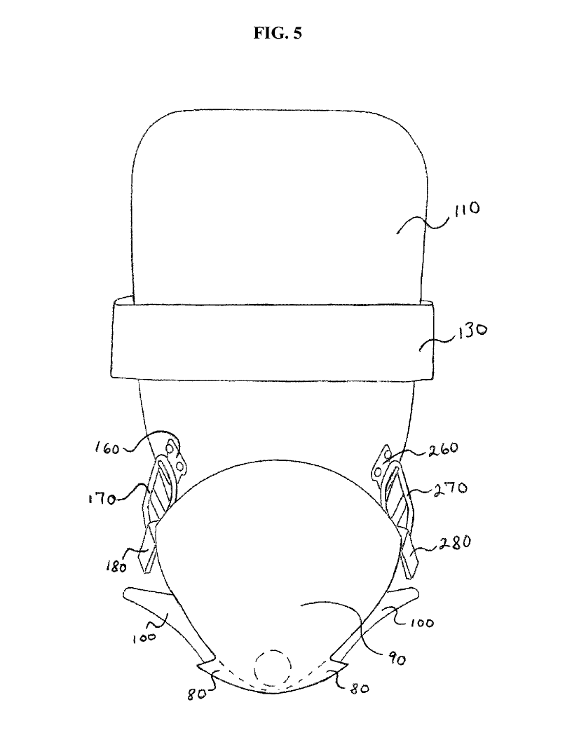

FIG. 5 is a bottom view of one embodiment of the present invention. Foot member 110 is fixedly attached to clasps 160 and 260. Release levers 180 and 280 are fixedly attached to loops 170 and 270, which are portrayed in a locked position with clasps 160 and 260. The current view point of the distal portion of the connective member 90 effectively hides how release levers 180 and 280 are also fixedly attached to calf member 100. The proximate portion of the connective member 80 is fixedly attached to calf member 100. Foot accommodating strap 130 can be fixedly attached to foot member 110.

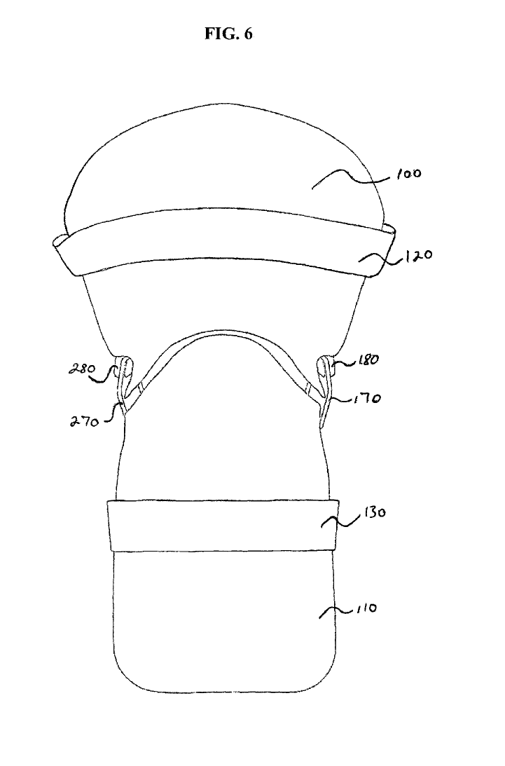

FIG. 6 is a top view of one embodiment of the present invention. Calf member 100 is fixedly attached to release levers 180 and 280, which are fixedly attached to loops 170 and 270. The current view point effectively hides how loops 170 and 270 are secured in a locked position with clasps 160 and 260, which are fixedly attached to foot member 110. Calf accommodating strap 120 can be fixedly attached to calf member 100. Foot accommodating strap 130 can be fixedly attached to foot member 110.

While the present invention has been described as having an exemplary design, it may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A device for rehabilitating a human appendage comprising:
a ball-and-socket joint, comprising a spherical ball enclosed by a proximal socket hemisphere and a distal socket hemisphere;
said ball-and-socket joint having a bisected hemisphere member radiating outward from said spherical ball, comprising a proximal socket quartersphere member and a distal socket quartersphere member;
a connective member fixedly attached to said proximal socket quartersphere member and said distal socket quartersphere member;
wherein said proximal socket quartersphere member is fixedly attached to a calf member;
wherein said distal socket quartersphere member is fixedly attached to a foot member;
a leg accommodating strap fixedly connected to said calf member; and
a foot accommodating strap fixedly connected to said foot member.

2. The device according to claim 1 further comprising at least one cord fixedly connected to said foot member, said cord having a length long enough to be grasped by a user.

3. The device according to claim 1 further comprising at least one removable latch system fixedly connecting said calf member to said foot member.

4. The device according to claim 1 further comprising a padding fixedly connected to said calf member and/or said foot member.

5. The device according to claim 1 further comprising a means for adding weight to the foot member.

6. The device according to claim 1, wherein the foot member is removably attached to a machine that provides continuous passive motion.

7. The device according to claim 1, wherein the foot member and the calf member are removably attached to a machine that provides continuous passive motion.

8. The device according to claim 1, wherein the ball-and-socket joint is removably attached to a machine that provides continuous passive motion.

9. The device according to claim 1, wherein the foot member and the calf member are removably attached to a machine that measures the angular range of motion of the foot member in relation to the calf member.

10. The device according to claim 1, wherein the foot member and the calf member are removably attached to a machine that measures the force required to move the foot member in relation to the calf member.

11. A method for rehabilitating a human appendage, wherein:
the leg accommodating strap of the device according to claim 1 is secured to a wearer's calf,
the foot accommodating strap of the device is secured to the wearer's foot, and
at least one strap fixedly connected to said foot member is grasped by the wearer or a user to provide guidance and/or resistance for exercise movements.
